(19) United States
(12) Patent Application Publication
(10) Pub. No.: US 2024/0388832 A1
(43) Pub. Date: Nov. 21, 2024

(54) EARPHONES WEARING DETECTION METHOD, DEVICE, APPARATUS, AND COMPUTER-READABLE STORAGE MEDIUM

(71) Applicant: GOERTEK TECHNOLOGY CO., LTD., Qingdai, Shandong (CN)

(72) Inventor: Guiquan Ni, Shandong (CN)

(73) Assignee: GOERTEK TECHNOLOGY CO., LTD., Qingdao, Shandong (CN)

(21) Appl. No.: 18/686,259

(22) PCT Filed: Dec. 23, 2021
(86) PCT No.: PCT/CN2021/140724

§ 371 Date: Feb. 23, 2024

(30) Foreign Application Priority Data
Aug. 23, 2021 (CN) 202110970071.4

(51) Int. Cl. H04R 1/10; G06V 40/16

(52) U.S. Cl. CPC H04R 1/1041; G06V 40/166; G06V 40/172; H04R 2430/01

(57) ABSTRACT

The present disclosure discloses an earphone wearing detection method, device, apparatus, and computer-readable storage medium. The method comprising: acquiring ear data of a user collected during a wearing process of an earphone; identifying the user based on the ear data of the user and pre-stored ear data of an owner of the earphone, to judge whether the user is the owner: if the user is the owner, judging whether a distance between an ear thereof and the earphone is decreasing, if the distance is decreasing, controlling the earphone to enter a normal using state; or if the distance is not decreasing, controlling the earphone to enter an off state.

### CROSS-REFERENCE TO RELATED APPLICATIONS

This application is a National Stage of International Application No. PCT/CN2021/140724, filed on Dec. 23, 2021, which claims priority to Chinese Patent Application No. 202110970071.4, filed on Aug. 23, 2021, both of which are hereby incorporated by reference in their entireties.

### TECHNICAL FIELD

The present disclosure relates to the field of wearable device technologies, and in particular to an earphone wearing detection method, device, apparatus, and computer-readable storage medium.

### BACKGROUND

With the outbreak of wearable products, TWS (True Wireless Stereo) earphone have come into people's lives and have been favored by the majority of consumers. Meanwhile, more and more attention are being paid to protection of privacy. At present, as long as an earphone is successfully connected to a mobile device, a user can use the earphone without undergoing an identification on identity of the user, which may allow personnels other than the owner of the earphone to use it. In addition, when the user uses the earphone, the earphone may be taken away by others during the call to eavesdrop on the call content, leading to leakage of the user's privacy and influencing the user's experience.

In view of this, how to provide an earphone wearing detection method, device, apparatus, and computer-readable storage medium that solve the above technical problems has become a problem to be solved by those skilled in the art.

### SUMMARY

The purpose of the embodiments of the present disclosure is to provide an earphone wearing detection method, device, apparatus, and computer-readable storage medium, which can effectively prevent personnels other than the owner from using earphone during use, and improve user safety and privacy security.

To solve the above-mentioned technical problems, the embodiments of the present disclosure provide an earphone wearing detection method, the method comprising:

Acquiring ear data of a current user collected during a wearing process of an earphone;
identifying the current user based on the ear data of the current user and pre-stored ear data of an owner of the earphone, to judge whether the current user is the owner: if the current user is the owner, judging whether a distance between an ear thereof and the earphone is gradually decreasing, if the distance is decreasing, controlling the earphone to enter a normal using state; or if the distance is not decreasing, controlling the earphone to enter an off state.

Optionally, after judging the current user is the owner, the method further comprises:
analyzing the ear data of the current user to determine a target age group corresponding to the current user;
determining a target maximum volume corresponding to the current user based on a pre-stored correspondence between age groups and maximum volumes;
setting a maximum volume of the earphone based on the target maximum volume.

Optionally, the method further comprises:
inspecting an audio file received to judge whether content of the audio file meets requirements of the target age group: if the content of the audio file does not meet the requirements, controlling the earphone to refrain from playing the audio file, or if the content of the audio file meets the requirements, controlling the earphone to play the audio file.

Optionally, the method further comprises:
when it is determined that the content of the audio file does not meet the requirements of the target age group, a voice prompt is provided to indicate that the content is not suitable to be played.

Optionally, a process of acquiring collected ear data of the current user comprises:
acquiring ear 3D data of the current user collected by a 3D LiDAR provided at an in-ear part of the earphone;
then, a process of identifying the current user based on the ear data of the current user and pre-stored ear data of the owner of the earphone to judge whether the current user is the owner comprises:
judging whether the ear 3D data is consistent with pre-stored ear 3D data: if they are consistent, determining that the current user is the owner, if they are inconsistent, determining that the current user is not the owner.

Optionally, a process of determining whether the distance between the earphone and the ear is gradually decreasing comprises:
acquiring a current distance between the earphone and the ear;
judging whether the current distance is less than a distance of a previous timing:
if the current distance is less than the distance of the previous timing, then judging whether the current distance is less than or equal to a preset distance value, if the current distance is less than or equal to the preset distance value, determining that the distance is decreasing, if the current distance is greater than the preset distance value, then acquiring a distance of a next timing, and taking the distance of the next timing as the current distance, and return to a step of judging whether the current distance is less than the distance of the previous timing;
if the current distance is not less than the distance of the previous timing, determining that the distance is not decreasing.

The embodiments of the present disclosure provide an earphone wearing detection device, comprising:
an acquiring module, configured to acquire ear data of a current user collected during a wearing process of an earphone;
a recognizing module, configured to identify the current user and judging whether the current user is the owner based on the ear data of the current user and ear data of an owner of the earphone stored previously, and if the current user is the owner, a judging module is triggered;
the judging module, configured to judge whether a distance between an ear thereof and the earphone is gradually decreasing: if the distance is decreasing, a first control module is triggered; if the distance is not decreasing, a second control module is triggered;
the first control module, configured to control the earphone to enter a normal using state;
the second control module, configured to control the earphone to enter an off state.

Optionally, the device further comprises:
an analyzing module, configured to analyze the ear data of the current user to determine a target age group corresponding to the current user;
a determining module, configured to determine a target maximum volume corresponding to the current user based on a pre-stored correspondence between age groups and maximum volumes; and
a setting module, configured to set a maximum volume of the earphone based on the target maximum volume.

The embodiments of the present disclosure provide an earphone wearing detection apparatus comprising a collector, a memory, and a processor; wherein:
the collector is configured to collect ear data of a current user during a wearing process of an earphone;
the memory is configured to store computer programs;
the processor is configured to implement steps of the earphone wearing detection method according to any one of claims 1 to 6 when executing the computer programs.

The embodiments of the present disclosure provide a computer-readable storage medium storing computer programs, and the computer programs are executed by a processor to implement steps of the earphone wearing detection method above mentioned.

The embodiments of the present disclosure provide an earphone wearing detection method, device, apparatus, and computer-readable storage medium. The method comprises: acquiring ear data of a current user collected during a wearing process of an earphone; identifying the current user based on the ear data of the current user and pre-stored ear data of an owner of the earphone, to judge whether the current user is the owner: if the current user is the owner, judging whether a distance between an ear thereof and the earphone is gradually decreasing: if the distance is decreasing, controlling the earphone to enter a normal using state; or if the distance is not decreasing, controlling the earphone to enter an off state.

It can be seen that in the present disclosure, ear data of the current user collected is acquired during the earphone wearing process, and based on the ear data of the current user and the ear data of an owner of the earphone stored previously, the current user can be identified. When it is determined that the current user is the owner, it is further determined whether the distance between the earphone and the ear is gradually decreasing. If the distance is decreasing, it indicates that the owner is continuing to wear the earphone. At this time, the earphone can be controlled to enter the normal using state. If the distance is not decreasing, it indicates that the earphone may be using by others after successful identity recognition, and there is a risk of privacy eavesdropping. At this time, the earphone can be controlled to enter an off state to prevent privacy eavesdropping by others. That is to say, the user can use the earphone normally, and the present disclosure can prevent personnels other than the owner from using the earphone. The present disclosure can effectively prevent personnels other than the owner from using earphone during use, improving user safety and privacy security.

### BRIEF DESCRIPTION OF THE DRAWINGS

In order to illustrate the technical solution in the embodiments of the present disclosure more clearly, a brief introduction will be given below to the accompanying drawings required in prior art and the embodiments. It is obvious that the accompanying drawings described below are only some embodiments of the present disclosure. For those skilled in the art, other accompanying drawings can be obtained based on these drawings without creative labor.

FIG. 1 is a flowchart of an earphone wearing detection method provided in an embodiment of the present disclosure;

FIG. 2 is a schematic illustration of a structure of an earphone wearing detection device provided in an embodiment of the present disclosure.

### DETAILED DESCRIPTION

The embodiments of the present disclosure provide an earphone wearing detection method, device, apparatus, and computer-readable storage medium, which can effectively prevent personnels other than the owner from using earphone during use, and improve user safety and privacy security.

In order to clarify the purpose, technical solution, and advantages of the embodiments of the present disclosure, the following will provide a clear and complete description of the technical solution in the embodiments of the present disclosure in conjunction with the accompanying drawings. Obviously, the described embodiments are a part of the embodiments of the present disclosure, not all of them. Based on the embodiments in the present disclosure, all other embodiments obtained by those skilled in the art without creative labor fall within the scope of the present disclosure.

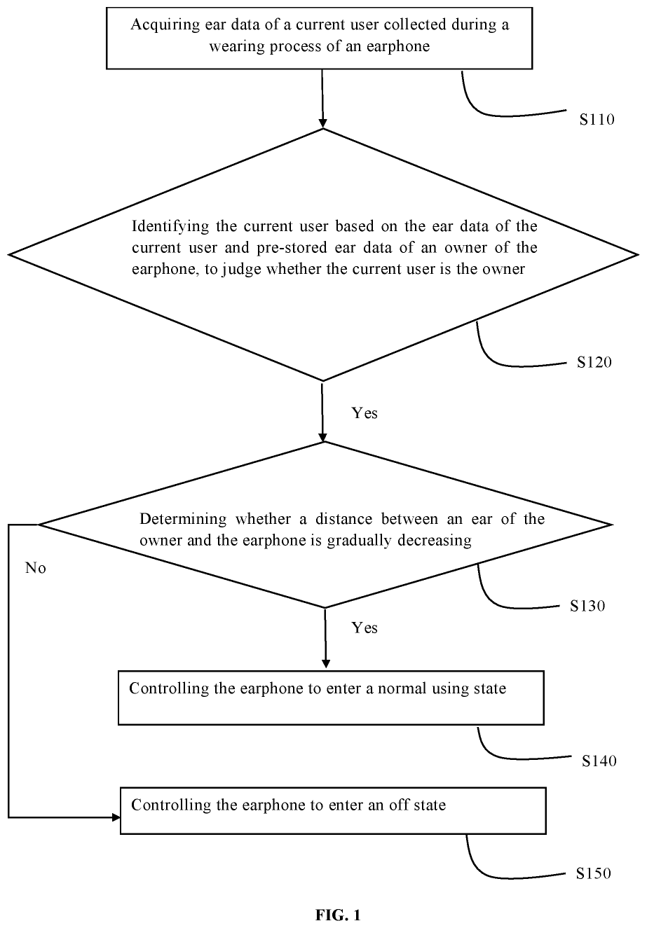

Referring to FIG. 1, FIG. 1 is a flowchart of an earphone wearing detection method provided in an embodiment of the present disclosure. The method comprises:

S1110: acquiring ear data of a current user collected during a wearing process of an earphone.

In particular, when the user use the earphone (such as a TWS earphone), a collector can be configured to collect ear data of the current user during a wearing process of an earphone, wherein the collector can be a 3D LiDAR, which scans the ears. Then, the collected ear data is 3D ear data, that is, ear 3D data.

A LIDAR consists of three parts: a transmitting system, a receiving system, and an information processing part. The working principle of the LiDAR is to use the emission, reflection, and reception of visible and near-infrared light waves (mostly infrared light near the 950 nm wavelength band) to detect objects, which is more accurate than a general radar. For example, solid-state LiDAR can be used, which is divided into OPA (optical phased array) solid-state LiDAR and Flash solid-state LiDAR. Based on its size and operational suitability, the Flash solid-state LiDAR can be selected. One major advantage of the Flash solid-state LiDAR is that it can quickly record the entire scene, avoiding various troubles caused by movement of a target or the LiDAR during the scanning process.

It should be noted that in practical applications, when the distance between the earphone and the ear is detected to be less than a first preset value, the 3D LiDAR can be automatically turned on and scan, or when the user wears the earphone, the scanning function can be turned on by a function button provided on the earphone to enable the 3D LiDAR to scan the ear, and when the distance between the earphone and the ear is a specific value, effective 3D scanning of the ear can be completed.

S120: identifying the current user based on the ear data of the current user and pre-stored ear data of an owner of the earphone, to judge whether the current user is the owner: if the current user is the owner, turn to S130;

It should be noted that the current user may be identified first. When it is determined that the current user is the owner of the earphone, the subsequent process can be proceeded. If it is determined that the current user is not the owner of the earphone, the earphone can be directly controlled to enter the off state. When the owner of the earphone uses the earphone for the first time, the ear data (specifically ear 3D data) of the owner can be collected and stored in a database. Then, each time the earphone is used, the ear data of the current user collected each time can be matched with the ear data of the owner stored previously to judge whether the current user is the owner.

Specifically, when the ear 3D data of the current user is obtained, the identity of the current user can be further identified by judging whether the ear 3D data is consistent with the pre-stored ear 3D data. When the ear 3D data of the current user is consistent with the pre-stored ear 3D data, it is determined that the current user is the owner. When the ear 3D data of the current user is inconsistent with the pre-stored ear 3D data, it is determined that the current user is not the owner.

In addition, if the earphone is authorized to multiple users, the ear data of the authorized users can be collected in advance and stored respectively in the database. After acquiring the ear data of the current user, the ear data of the current user can be matched with each ear data stored in the database. If there is ear data that is consistent with the ear data of the current user, it indicates that the current user is one of the authorized users, and it can be determined that the current user is the owner.

S130: judging whether the distance between the earphone and the ear is gradually decreasing. If the distance is decreasing, turn to S140; or if the distance is not decreasing, turn to S150;

S140: controlling the earphone to enter a normal using state;

S150: controlling the earphone to enter an off state.

It should be noted that after identifying the current user as the owner of the earphone, in order to prevent the earphone from being further used by others and prevent privacy calls from being leaked, the distance between the earphone and the ear can be determined in the embodiment of the present disclosure. If the distance is gradually decreasing, it indicates that the user is wearing the earphone, that is, the user is wearing the earphone on his own ear. At this time, the earphone can be controlled to enter a normal using state, that is, the earphone can be used normally. Specifically, the earphone can be controlled to enter the normal using state when the distance between the earphone and the ear is detected to be less than or equal to the preset distance value (such as 1 cm, the specific value can be determined according to actual needs). If the distance gradually increases, it indicates that the user does not wear the earphone on his own ear after identity recognition, but kept the earphone away from his own ear. In order to prevent the earphone from being worn on ears of a personnel other than the owner, the earphone can be controlled to enter the off state, that is, the earphone cannot be used normally at this time.

The process of judging whether the distance between the earphone and the ear is gradually decreasing in S130 above is: to obtain the current distance between the earphone and the ears; judge whether the current distance is less than the distance of a previous timing. If the current distance is less than the distance from the previous timing, judge whether the current distance is less than or equal to a preset distance value. If the current distance is less than or equal to the preset distance value, it is determined that the distance between the earphone and the ear is gradually decreasing. At this time, the earphone can be controlled to enter normal using state. If the current distance is greater than the preset distance value, the detection is continued, that is to say, continue to obtain a distance of a next timing, take the distance of the next timing as the current distance, return to the step of judging whether the current distance is less than the distance of the previous timing, until it is detected that the current distance is not less than the distance of the previous timing, or it is detected that the current distance is less than or equal to the preset distance value, and enter the corresponding step. Specifically, if the current distance is not less than the distance from the previous timing, it is determined that the distance between the earphone and the ear does not gradually decrease, and controlling the earphone to enter the off state.

Further, after judging the current user is the owner, the method also comprises:
analyzing the ear data of the current user to determine a target age group corresponding to the current user;
determining a target maximum volume corresponding to the current user based on a pre-stored correspondence between age groups and maximum volumes; and
setting a maximum volume of the earphone based on the target maximum volume.

It should be noted that due to the different maximum sound intensities that users of different age groups can withstand in their ears, especially for young children and other young age groups, their ability to withstand sound is weak. In order to further protect ears of the user and prevent hearing damage (for example, to prevent the volume suitable for adults from causing hearing damage to toddlers and children), in the embodiments of the present disclosure, age can be divided into multiple age groups, and the maximum volume corresponding to each age group is set. When the user is using the earphone, after judging that the current user is the owner, the ear data of the current user is analyzed. Specifically, by analyzing parameters such as ear size, the target age group corresponding to the current user is further determined. Ear data of a large amount of user can be collected in advance, and through statistical analysis, the corresponding ear size range for each age group of users can be determined. Then, during the user's use of the earphone, the ear size of the ear data of current user collected can be matched with the pre-established ear size range corresponding to each age group, thereby acquiring the target age group corresponding to the current user. Then, based on the target age group and the correspondence between age groups and maximum volumes, the target maximum volume is further determined. Then, the maximum volume of the earphone is set according to the target maximum volume, so that the volume of the sound played during the use of the earphone does not exceed the target maximum volume to avoid damage to ears of the user.

Further, the method may also comprise:
inspecting an audio file received to judge whether content of the audio file meets requirements of the target age group, if the content of the audio file does not meet the requirements, controlling the earphone to refrain from playing the audio file, and if the content of the audio file meets the requirements, controlling the earphone to play the audio file.

It should be noted that due to the inevitable involvement of negative content in modern networks, in order to avoid these contents affecting the physical and mental health of adolescents, in the embodiment of the present disclosure, when playing audio files through earphone (such as listening to music or broadcasting), the received audio files can be detected. Specifically, the content in the audio files can be detected through tag content such as keywords. For example, different detection keywords for different age groups are set in advance, and target detection keywords corresponding to the target age group are used to detect the received audio file. If content corresponding to the target detection keywords are detected in the audio file, it can be determined that the audio file is not suitable for the age group of the current user. At this time, the earphone can be controlled to refrain from playing the audio file. Of course, Users can also be reminded by voice that the content is not suitable for playback, so that the user can change the content. If it is determined that there is no corresponding target detection keyword in the audio file, it indicates that the audio file is suitable for the age group of the current user. At this time, the earphone can be controlled to play the audio file.

It can be seen that in the present disclosure, ear data of the current user collected is obtained during the earphone wearing process, and based on the ear data of the current user and the ear data of an owner of the earphone stored previously, the current user can be identified. When it is determined that the current user is the owner, it is further determined whether the distance between the earphone and the ear is gradually decreasing. If the distance is decreasing, it indicates that the owner is continuing to wear the earphone. At this time, the earphone can be controlled to enter the normal using state. If the distance is not decreasing, it indicates that the earphone may be used by others after successful identity recognition, there is a risk of privacy eavesdropping. At this time, the earphone can be controlled to enter the off state to prevent privacy eavesdropping by others. That is to say, the user can use the earphone normally, and the present disclosure can prevent personnels other than the owner from using the earphone. The present disclosure can effectively prevent personnels other than the owner from using earphone during use, improving user safety and privacy security.

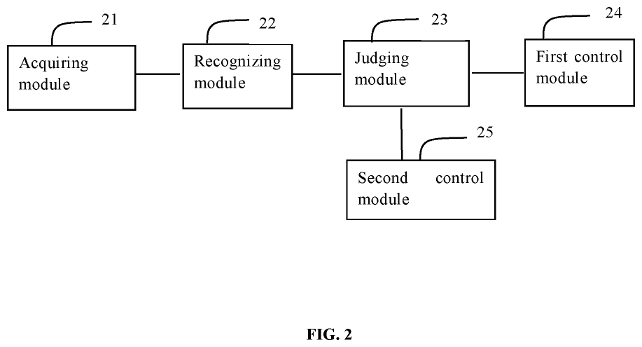

On the basis of the above embodiments, the present disclosure also provides an earphone wearing detection device, as shown in FIG. 2. The device comprises:
an acquiring module 21, configured to acquire ear data of a current user collected during a wearing process of an earphone;
a recognizing module 22, configured to identify the current user based on the ear data of the current user and pre-stored ear data of an owner of the earphone, to determine whether the current user is the owner, and if the current user is the owner, a judging module 23 is triggered;
the judging module 23, configured to judge whether a distance between an ear thereof and the earphone is gradually decreasing: If the distance is decreasing, a first control module 24 is triggered; if the distance is not decreasing, a second control module 25 is triggered;
the first control module 24, configured to control the earphone to enter a normal using state; and
the second control module 25, configured to control the earphone to enter an off state.

Optionally, the device may also comprise:
an analyzing module, configured to analyze the ear data of the current user to determine a target age group corresponding to the current user;
a determining module, configured to determine a target maximum volume corresponding to the current user based on a pre-stored correspondence between age groups and maximum volumes;
a setting module, configured to set a maximum volume of the earphone based on the target maximum volume.

It should be noted that the earphone wearing detection device provided in the embodiments of the present disclosure has the same beneficial effect as the earphone wearing detection method provided in the above embodiments. With regard to the specific introduction of the earphone wearing detection method involved in the embodiments of the present disclosure, please refer to the above embodiments, which will not be repeated in the present disclosure.

On the basis of the above embodiments, the present disclosure also provides an earphone wearing detection apparatus comprising a collector, a memory, and a processor; wherein:
the collector is configured to collect ear data of a current user during a wearing process of an earphone;
the memory is configured to store computer programs;
the processor is configured to implement steps of the earphone wearing detection method according to any one of claims 1 to 6 when executing the computer programs.

For example, the processor in the embodiments of the present disclosure can be specifically used to obtain ear data of a current user collected during a wearing process of an earphone; based on the ear data of the current user and ear data of an owner of the earphone stored previously, identify the current user and determine the current user is the owner, if the current user is the owner, judging whether a distance between an ear thereof and the earphone is gradually decreasing, if the distance is decreasing, controlling the earphone to enter a normal using state; or if the distance is not decreasing, controlling the earphone to enter an off state.

On the basis of the above embodiments, the embodiments of the present disclosure also provides a computer-readable storage medium. The computer-readable storage medium stores computer programs, and the computer programs are executed by a processor to implement steps of the above earphone wearing detection method.

The computer-readable storage medium can include: USB flash drives, portable hard drives, Read Only Memory (ROM), Random Access Memory (RAM), disks or CDs, and other mediums that can store program code.

The various embodiments in the specification are described in a progressive manner, and each embodiment focuses on the differences from other embodiments. The same and similar parts between each embodiment can be referred to each other. For the device disclosed in the embodiments, as the device corresponds to the method disclosed in the embodiments, the description is relatively simple. Please refer to the section of the method for relevant information.

It should also be noted that in this manual, relational terms such as first and second are only used to distinguish one entity or operation from another entity or operation, and do not necessarily require or imply any actual relationship or order between these entities or operations. Moreover, the terms “include”, “comprise”, or any other variation thereof are intended to encompass non-exclusive inclusion, such that a process, method, item, or apparatus that includes a series of elements not only includes those elements, but also includes other elements that are not explicitly listed, or also includes elements inherent to such process, method, item, or apparatus. Without further limitations, the elements limited by the statement “comprise one . . . ” do not exclude the existence of other identical elements in the process, method, item, or apparatus that includes the elements.

The above explanation of the disclosed embodiments enables professionals in the art to implement or use the present disclosure. The various modifications to these embodiments will be apparent to professionals in the art. The general principles defined herein can be implemented in other embodiments without departing from the spirit or scope of the present disclosure. Therefore, the present disclosure will not be limited to the embodiments herein, but will conform to the widest range consistent with the principles and novel features disclosed herein.

1. An earphone wearing detection method, comprising:
acquiring ear data of a user collected during a wearing process of an earphone; and
identifying the user based on the ear data and pre-stored ear data of an owner of the earphone, to judge whether the user is the owner:
if the user is the owner, judging whether a distance between an ear thereof and the earphone is decreasing;
if the distance is decreasing, controlling the earphone to enter a normal using state; or
if the distance is not decreasing, controlling the earphone to enter an off state.

2. The earphone wearing detection method according to claim 1, wherein after judging the user is the owner, the method further comprises:
analyzing the ear data of the user to determine a target age group corresponding to the user;
determining a target maximum volume corresponding to the user based on a pre-stored correspondence between the age groups and the maximum volume; and
setting a maximum volume of the earphone based on the target maximum volume.

3. The earphone wearing detection method according to claim 2, further comprising:
inspecting an audio file received to judge whether content of the audio file meets requirements of the target age group;
if the content of the audio file does not meet the requirements, controlling the earphone to refrain from playing the audio file, or
if the content of the audio file meets the requirements, controlling the earphone to play the audio file.

4. The earphone wearing detection method according to claim 3, further comprising:
when the content of the audio file does not meet the requirements of the target age group, a voice prompt is provided to indicate that the content is not suitable to be played.

5. The earphone wearing detection method according to claim 1, wherein acquiring ear data of the user comprises:
acquiring ear 3D data of the user collected by a 3D LiDAR provided at an in-ear part of the earphone;
then, identifying the user based on the ear data of the user and pre-stored ear data of the owner of the earphone to judge whether the user is the owner comprises:
judging whether the ear 3D data is consistent with pre-stored ear 3D data:
if they are consistent, determining that the user is the owner; or
if they are inconsistent, determining that the user is not the owner.

6. The earphone wearing detection method according to claim 1, wherein determining whether the distance between the earphone and the ear is decreasing comprises:
acquiring a current distance between the earphone and the ear;
judging whether the current distance is less than a distance of a previous timing:
if the current distance is less than the distance of the previous timing, then judging whether the current distance is less than or equal to a preset distance value:
if the current distance is less than or equal to the preset distance value, determining that the distance is decreasing, or if the current distance is greater than the preset distance value, then acquiring a distance of a next timing, and taking the distance of the next timing as the current distance, and returning to judging whether the current distance is less than the distance of the previous timing; or
if the current distance is not less than the distance of the previous timing, determining that the distance is not decreasing.

7. An earphone wearing detection device, comprising:
an acquiring module, configured to acquire ear data of a user collected during a wearing process of an earphone;
a recognizing module, configured to identify the user based on the ear data of the user and pre-stored ear data of an owner of the earphone, to determine whether the user is the owner;
a judging module, configure to be triggered if the user is the owner and a judging module is triggered
to judge whether a distance between an ear thereof and the earphone is decreasing;
a first control module, configured to be triggered if the distance is decreasing and to control the earphone to enter a normal using state; and
a second control module, configured to be triggered if the distance is not decreasing and
to control the earphone to enter an off state.

8. The earphone wearing detection device according to claim 7, further comprising:
an analyzing module, configured to analyze the ear data of the user to determine a target age group corresponding to the user;
a determining module, configured to determine a target maximum volume corresponding to the user based on a pre-stored correspondence between the age group and the maximum volumes; and
a setting module, configured to set a maximum volume of the earphone based on the target maximum volume.

9. An earphone wearing detection apparatus, comprising a collector, a memory, and a processor; wherein:
the collector is configured to collect ear data of a user during a wearing process of an earphone;
the memory is configured to store computer programs; and
the processor is configured to implement an earphone wearing detection method according to claim 1 when executing the computer programs.

10. A computer-readable storage medium storing computer programs thereon, wherein the computer programs are configured to be executed by a processor to implement an earphone wearing detection method according to claim 1.
